(19) United States
(12) Patent Application Publication
(10) Pub. No.: US 2008/0047719 A1
(43) Pub. Date: Feb. 28, 2008

(54) FIRE EXTINGUISHING SYSTEM

(76) Inventor: Oskar Levander, Turku (FI)

Correspondence Address: SMITH-HILL AND BEDELL, P.C., 16100 NW CORNELL ROAD, SUITE 220, BEAVERTON, OR, 97006, US

(21) Appl. No.: 11/464,882

(22) Filed: Aug. 16, 2006

(51) Int. Cl. A62C 3/08

(52) U.S. Cl. 169/62; 169/56; 169/61

(57) ABSTRACT

A fire extinguishing system for a marine structure having an engine room and a fuel cell arrangement that is located in the engine room and includes at least one fuel cell module, and includes a fire detection system for detecting fire in the fuel cell module and a nozzle for releasing a fire extinguishing medium into the fuel cell module.

### BACKGROUND OF THE INVENTION

The present invention relates to a fire extinguishing system for a marine structure comprising an engine room and a fuel cell arrangement.

Engine rooms or machinery spaces of marine structures, such as marine vessels, oil drilling platforms, LNG stations, etc., generally have to be provided with a fire extinguishing system. Typically this is a CO₂ system designed for the entirety of the engine room. Furthermore, so-called prime movers must have a local fire fighting system. In practice this usually means that water mist sprinklers are provided above the engines or other machinery equipment.

The CO₂ system is efficient as such, but it can not be employed before the entire engine room is evacuated, i.e. cleared of personnel. This most often means that there is a delay in releasing the CO₂, which increases the impact of the fire. In order to remedy such situations, local fire fighting systems as discussed above are required. The local sprinklers may then be deployed as soon as the fire is detected.

The above is relevant for more conventional machinery arrangements. However, fuel cell arrangements are becoming more frequent. In case of a fire involving a fuel cell arrangement, the delay associated with deployment of the main CO₂ system for the engine room may result in increased damage to the fuel cell arrangement. Also the effect of CO₂ released in an engine room around the fuel cell arrangement would be inefficient both for the reasons mentioned above (increased impact of fire due to the need to evacuate personnel) and because the extinguishing effect would not be focused on the fuel cell arrangement. Moreover, conventional local fire fighting systems employing water mist are not well suited for fires involving electrical components, since they would create risks of short circuiting and cause damage to the fuel cell arrangement.

An object of the present invention is to avoid the drawbacks of known solutions and to provide an effective and simple fire extinguishing system for a marine fuel cell arrangement.

### SUMMARY OF THE INVENTION

The basic idea of the invention is to apply a local fire extinguishing system within the fuel cell arrangement, which comprises at least one fuel cell module. Each fuel cell module is provided with at least one fire detection sensor and at least one internal nozzle for releasing a fire extinguishing medium into the fuel cell module. Primarily this offers a better fire fighting capability and a quick response, i.e. a possibility to start the fire fighting earlier with less damage to the equipment. This also lessens the risk of casualties. Particularly this offers the advantage to fight a small fire without any risk of additional damage in connection with a larger fire fighting process.

The fuel cell module normally comprises a number of separate components, whereby the fuel cell module advantageously may be provided with at least one auxiliary nozzle for releasing fire extinguishing medium to one or more of the separate components. Such components typically include a hot box, including a fuel cell stack, a fuel reformer, an electric inverter, power conditioning, a process gas heater, a control unit, etc. The benefit would be an increased fire extinguishing effect focused directly at the actual source of fire. The auxiliary nozzles may be effective in immediately extinguishing a tiny fire, without incapacitating the function of the fuel cell module in general.

Preferably the fuel cell module is located within a container structure, whereby e.g. the dimensioning and the control of the fire fighting system may be designed more exactly to increase efficiency, also with a benefit of cost effectiveness.

The fire detection sensor advantageously comprises a smoke detector and/or a heat detector, whereby also detection of gas fires would be sufficiently ensured.

The fire extinguishing medium nozzle and, if employed, auxiliary nozzle may be connected to a fire extinguishing medium supply comprising a dedicated container and/or a common supply network. This allows for utilizing the general fire extinguishing medium on board the marine vessel, depending on the substance, and also utilizing a specific fire fighting medium when desired.

Preferably the fire extinguishing medium comprises CO₂ which is both effective and generally available on board a marine vessel. CO₂ is also practical to use in the form of dedicated containers or bottles. In case the fuel cell arrangement comprises an MCFC (Molten Carbonate Fuel Cell) the CO₂ may be made available from the fuel recirculation process of the fuel cell process, which would reduce the need of an external supply of CO₂. As an alternative to CO₂ an inert gas, advantageously N2, may also be used. These arrangements ensure an improved extinguishing effect, reduced damage as well as an elimination of risks of electric short circuiting.

Additionally, water mist may be utilized as a supplementary fire extinguishing medium for specific purposes, such as for cooling a hot box of a fuel cell module or for cooling the walls and roof of a fuel cell module, or of an enclosing container structure, from the outside.

The fire extinguishing medium nozzle and, if employed, the auxiliary nozzle, are advantageously provided with a manual and/or automatic release means.

For further security, the fire extinguishing system is advantageously provided with automatic shutdown of e.g. air inlets, fuel feed devices, exhaust outlets, and any other connections of the fuel cell module to the surrounding in order to limit any spreading of the fire and to close the fuel cell module from the outside.

### BRIEF DESCRIPTION OF THE DRAWINGS

In the following the present invention is described in more detail, by way of example only, with reference to the attached schematic drawings, in which

FIG. 1 shows a first embodiment of a fire extinguishing system according to the invention, and

FIG. 2 shows a second embodiment of a fire extinguishing system according to the invention.

### DETAILED DESCRIPTION

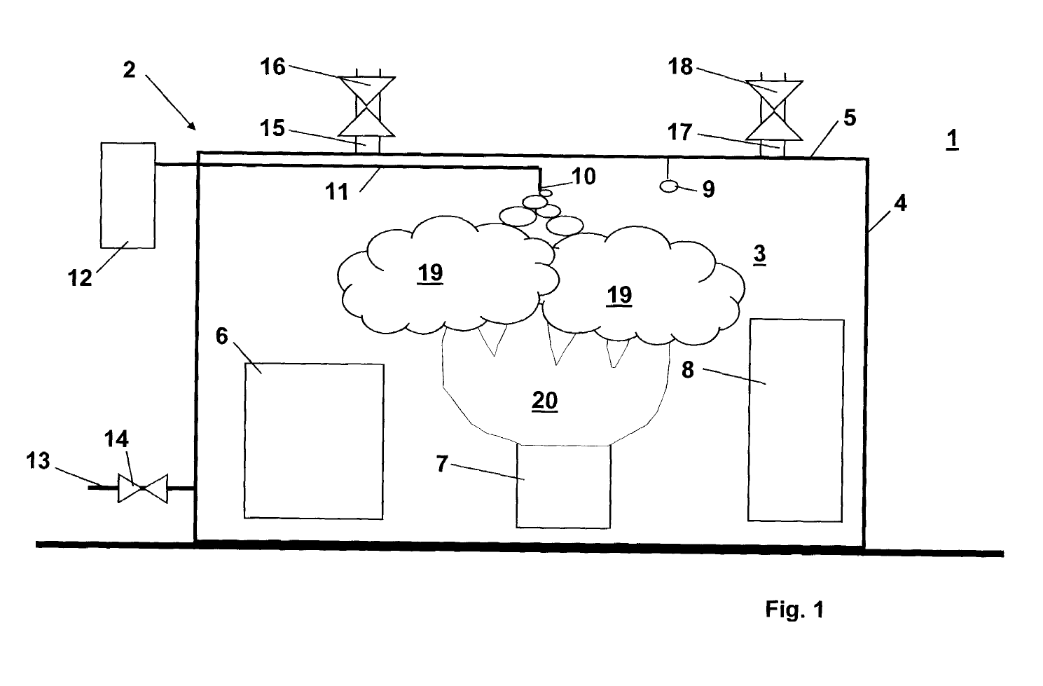

FIG. 1 shows a general view of a fuel cell arrangement in the form of a fuel cell module 2. The fuel cell module 2 is located in an engine room 1 of a marine vessel. In this embodiment the fuel cell module 2 is enclosed within a container structure 3 provided with side walls 4 and a roof 5. The fuel cell module 2 comprises a number of components. FIG. 1 only generally indicates some components as an example, i.e. a fuel cell stack 6, auxiliary equipment 7, including e.g. a fuel reformer, heat exchangers, pumps, etc. and a power conditioning apparatus 8, including e.g. an electric inverter and a transformer.

The fuel cell module is provided with a fire detection sensor 9 inside the module. The fire detection sensor 9 advantageously comprises a smoke detector and a heat detector in order to ensure the detection of gas fires. Furthermore, the fuel cell module 2 comprises an internal nozzle 10 for releasing a fire extinguishing medium into the fuel cell module. The fire detection sensor 9 and the internal nozzle 10 are located in the vicinity of the roof 5 of the container structure 3. The internal nozzle 10 is in fluid communication with a fire extinguishing medium supply 12 outside the container structure 3 by means of a pipe 11.

The fire extinguishing medium supply may be a dedicated container or bottle or alternatively a supply network onboard the marine vessel. This depends on the circumstances and the choice of fire extinguishing medium.

A preferable fire extinguishing medium is CO₂ which provides excellent fire extinguishing qualities, and in addition, is generally found onboard marine vessels since it is commonly used for fire fighting, particularly in engine rooms, on marine vessels. In the latter case there usually is a CO₂ supply network onboard, to which network the fire extinguishing medium supply pipe 11 may be connected. CO₂ may of course by supplied in dedicated containers or bottles as well, which are connected to said pipe.

An alternative fire extinguishing medium could be an inert gas, such as N2.

The fuel cell module 2 is further provided with a fuel feed device 13 with a fuel shutdown vent 14, an exhaust outlet 15 with an exhaust shutdown vent 16 and an air inlet 17 with an inlet shutdown vent 18.

Basically the fuel cell module 2 thus provides a closed structure with respect to the surrounding engine room 1 where the fuel cell module 2 is located, except for means such as the above mentioned fuel feed device, exhaust outlet and air inlet, and possible other inlets and outlets to the engine room.

In the case of a fire in the fuel cell module 2, the fire detection sensor 9 reacts and may be programmed to immediately release a fire extinguishing medium from the fire extinguishing medium supply 12 through the pipe 11 to the internal nozzle 10, which then sprays the fire extinguishing medium, indicated by reference numeral 19, over the fire 20, which in FIG. 1 has started in the auxiliary equipment 7. The response is immediate and gives excellent fire damage control. By choosing a suitable fire extinguishing medium based on the target of the nozzle 10, any other damage to the pertinent component and any other components may be avoided. The release may also be arranged to be manual, if so desired.

The signal to release the fire extinguishing medium is advantageously coupled to an automatic shutdown of the connections of the fuel cell module 2 to the surrounding. In this embodiment this would mean the automatic closing of the fuel shutdown vent 14 of the fuel feed device 13, the exhaust shutdown vent 16 of the exhaust outlet 15 and the air inlet shutdown vent 18 of the air inlet 17. These measures would ensure the isolation of the fire to the fuel cell module.

These kinds of control systems and shutdown arrangements are not discussed in detail in this connection, since they are known to a person skilled in the art.

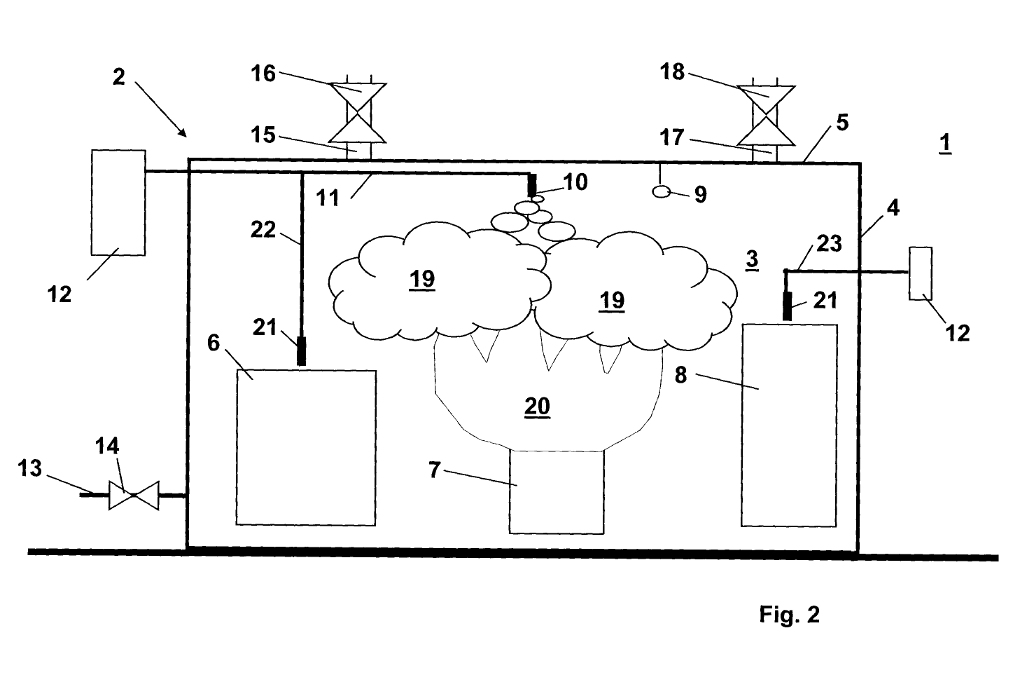

The embodiment according to FIG. 2 generally corresponds to the embodiment of FIG. 1, whereby the same reference numerals have been used for the corresponding parts, and are therefore not discussed in detail in connection with this embodiment.

In this embodiment, however, the fuel cell module 2 is provided with two auxiliary nozzles 21. One auxiliary nozzle 21 is located just above the fuel cell stack 6 and is in fluid communication with the fire extinguishing medium supply 12 through a branch line 22 connecting to the pipe 11. The other auxiliary nozzle 21 is located just above the power conditioning apparatus 8 and is in fluid communication with a fire extinguishing medium supply 12, in this case shown as a dedicated container or bottle, through an auxiliary pipe 23. The basic idea of this set up is to have a fire fighting system directly focused on one or more separate components.

The control and function of such auxiliary arrangements can generally be the same as discussed above. Furthermore, if desired, these arrangements could include dedicated fire detection sensors (not shown). The fuel cell module could also be provided only with such directly focused nozzles depending on its configuration.

In addition to the above, the fire extinguishing system according to the invention could have water mist as a supplementary fire extinguishing medium. In practice this could include water mist sprinklers (not shown) located at desired points, such as outside the sidewalls 4 and roof 5 of the container structure 3 for cooling purposes. Water mist sprinklers could also be located in connection with specific components. These supplementary arrangements should of course be designed so that the water would not cause thereto related damages, such as electric short circuiting.

In the description above, the present invention has been described only in relation to one fuel cell module. It is to be understood that engine rooms may comprise more than one, or even multiple fuel cell modules.

The drawings and the description related thereto are only intended for clarification of the basic idea of the invention. The invention may vary in detail within the scope of the ensuing claims.

1. A fire extinguishing system for a marine structure having an engine room and a fuel cell arrangement located in the engine room, wherein the fuel cell arrangement comprises at least one fuel cell module, and the fire extinguishing system comprises a fire detection system for detecting fire in the fuel cell module and a nozzle for releasing a fire extinguishing medium into the fuel cell module.

2. A fire extinguishing system according to claim 1, wherein the fuel cell module comprises a plurality of separate components and the fire extinguishing system comprises at least one auxiliary nozzle for releasing a fire extinguishing medium towards one or more of said components.

3. A fire extinguishing system according to claim 1, wherein the fuel cell module is located within a container structure.

4. A fire extinguishing system according to claim 1, wherein the fire detection system comprises at least one of a smoke detector and a heat detector.

5. A fire extinguishing system according to claim 1, comprising a fire extinguishing medium supply system to which the nozzle is connected.

6. A fire extinguishing system according to claim 5, wherein the fire extinguishing medium supply system comprises at least one of a dedicated container of fire extinguishing medium and a supply network for distributing fire extinguishing medium.

7. A fire extinguishing system according to claim 5, wherein the fire extinguishing medium comprises at least one of CO₂ and an inert gas.

8. A fire extinguishing system according to claim 1, further comprising a system for releasing water mist as a supplementary fire extinguishing medium.

9. A fire extinguishing system according to claim 1, comprising at least one of a manual release means and an automatic release means for releasing supply of fire extinguishing medium from the nozzle.

10. A fire extinguishing system according to claim 1, comprising a means for automatically shutting down utility services for the fuel cell module.

11. A marine structure having an engine room and comprising at least one fuel cell module located in the engine room, a fire detection system for detecting fire in the fuel cell module and issuing an alarm signal in response to detection of fire in the fuel cell module, and a nozzle for releasing a fire extinguishing medium into the fuel cell module.

12. A marine structure according to claim 11, comprising a fire extinguishing medium supply system and a control means for controlling supply of fire extinguishing medium from the supply system to the nozzle, and wherein the control means is responsive automatically to the alarm signal.

13. A marine structure according to claim 11, comprising a container in which the fuel cell module is located, and wherein the nozzle is internal of the container.

14. A marine structure according to claim 13, wherein the container is provided with utility connections for supplying services to the fuel cell module, and the structure further comprises a control means responsive to the alarm signal for automatically shutting off the utility connections.
